(19) United States
(12) Patent Application Publication
(10) Pub. No.: US 2011/0200779 A1
(43) Pub. Date: Aug. 18, 2011

(54) Adhesive Tape As Bag Cinch Device

(76) Inventor: Amy Lyn Wolfe, Cumming, GA (US)

(21) Appl. No.: 12/705,851

(22) Filed: Feb. 15, 2010

(51) Int. Cl. B32B 7/06; C09J 7/02

(52) U.S. Cl. 428/43; 428/343

(57) ABSTRACT

Adhesive tape for the purpose of cinching the open end of a bag, namely a plastic trash bag or like, around the exterior surface of a container for which the bag is intended to line, to create a neat, tightened bag edge for aesthetic and functional fitting needs, whereby the device is characterized by a body of tape, one surface having adhesive sections on the two ends of the length and an adhesive free zone in the mid section in which a cinched portion of the bag is gathered, leaving the rest of the bag opening edge smooth and tightened around the exterior surface of the container, and the tape further having a perforated separation-line in the latitudinal direction in or near the adhesive free zone for use in tearing the tape into two sections to release the tension on the bag when removing the bag from the container.

### FIELD OF THE INVENTION

The present invention relates to an adhesive tape, and more particularly, to an adhesive tape of the kind used for cinching in a tightening fashion a portion of a plastic bag around the exterior surface of a container to which the bag lines, and including a non-adhesive zone for the allowance of gathering a portion of the bag between the adhesive sections without binding it to the tape in that zone, which also acts as a finger grab area for the user during bag removal, further including a weakened area of the tape to release tension during removal of the bag from the container.

### BACKGROUND OF THE INVENTION

Prior art is intended for the purpose of the closure of plastic bags, and not for the cinching around the exterior of containers. Straight adhesive tape, a rope, or an elastic band could be utilized in tightening a bag around a container opening or surface, but all have significant deficiencies in regards to the removal of the bag from the container, are insufficient or non-existent in the allowances for the gathering area, have unattractive end resulting aesthetics, lack of ease of application and use, and none are designed specifically for the purpose of bag cinching around a container. Regular adhesive tape catches all portions of the bag to which it touches, creating a difficult application process for the user, and does not allow a controlled gathering of the portion of the bag being cinched, or easy tearing or removal once it is adhered. Ropes and elastic bands only gather the bag at the multiple pin point portions to which they touch and bind too far away from the bag opening edge, thereby leaving the edges of the bag opening loose and unkempt, and, furthermore, create a hardship on the user during removal of the bag from its container, often falling into the container, which is an undesirable result. Some prior art contains tabs for the tearing process of adhesive tape, which, for this use, would hinder the insertion of an inner container lined with a plastic bag into a decorative shell, such as a step-lid stainless-steel kitchen waste container, because the tab binds and/or catches on the outer container as the inner container is inserted. Some prior art includes tear-lines in the longitudinal direction along the length of the tape due to the intended use of that art being for a sealing and closure application of envelopes and mailing packages, and would not function in the capacity needed for the cinching application of a bag in or around a container, or in a stand alone fashion outside of their intended use. Some prior art shows minimal non-adhesive areas of a tape which are intended for uses such as a small tear line or removal of one piece of tape from another piece of tape, and are typically a significantly small area (usually a line) in proportion to the size of the section of tape. None are designed for the cinching of a gathered portion of the bag material around a container surface. Furthermore, an undesirable result can occur with an unrestrained bag that is loosely placed into a container, such as a waste container, when the insertion of the first item of any gravity into the bag has the unintended result of pulling the bag into the container, thereby causing the bag to no longer perform its duty of lining the container. In this case, the bag opening, which was placed in a fashion to wrap the opening of the container and seat along the outside surface of the container, may also be pulled into the container, causing the entire bag itself to fall into the bottom of the container, no longer protecting the inner surface of the container, as intended. Even if an unrestrained bag does not fall into the container upon the introduction of items into the bag, the unpleasing aesthetic appearance of a loose and unkempt bag in a container is undesired and prohibits placing that container into a subsequent decorative container holder, such as a stainless steel, step-lid kitchen waste container would employ. Some prior art includes the bag as part of the device, which defeats the purpose of the universal usability of an external and independent device such as tape type product applied to the bag. Furthermore, any of the prior art devices would not be universal for use in the infinite size and shapes of available waste containers on the market and in use in homes and offices.

### BRIEF SUMMARY OF THE INVENTION

The object of the invention is to provide an adhesive tape and method specifically designed for the particular purpose of gathering and cinching a section of the circumference of a plastic bag into a sufficiently proportionate sized non-adhesive zone in the mid section of the tape, so that the entire bag opening edge is tightened around the exterior surface of a container, resulting in an aesthetically pleasing as well as functionally secure fit over and around the container in which the bag is inserted, and further adding the convenience of an easy latitudinal tear-line across the width of the tape in or near the adhesive free zone to release the tension on the bag for the bag removal process, which overcomes the issues of any current products or art which were not intended for, but may attempt to be utilized for this application and function.

The invention comprises of a length of adhesive tape adapted for use in the gathering and cinching of a plastic bag opening around the exterior surface of a container.

The invention further comprises of a non-adhesive mid section of the length of the tape into which the gathered portion of the bag is captured by the permanent attachment of the adhesive ends of the tape onto either side of the gathered portion of the bag.

The invention further comprises of a weakened area, typically in the form of perforations in a lineal, latitudinal, direction along the width of the tape, next to and/or in the non-adhesive section of the tape, which provides a method for the user to tear the tape into two sections for the purpose of releasing the tension on the bag for removal of the bag from its container, allowing the invention to be discarded with the bag and contents as disposable.

The non-adhesive mid section is further utilized as a finger grab area for the user to release the tension on the bag by applying an upper, and/or downward, and outward pull pressure on the tape, thereby tearing the tape into two sections along the intended weakened, perforated, tear-line.

The non-adhesive zone may be accomplished by utilizing a fully lined adhesive tape and placing a non-adhesive material, such as a paper, plastic film, or coating over the intended zone rendering the mid section non-adhesive. Or, a non-adhesive tape or material may be used as the body (substrate) of the invention and an adhesive glue or tape placed on the surface of the end regions to create the adhesive areas, thereby leaving the mid section non-adhesive.

The device allows for the flexibility of use on any number of sizes and styles of bags and containers, and its effectiveness is only limited by the size of the gathered area of the bag in proportion to the non-adhesive zone of the device.

The manufactured size of the device is infinitely adjustable to meet the needs of the end user and should be proportionate according to the bags upon which it is intended to be used.

Appreciation lends to the understanding that it is not intended to limit the invention to use on trash bags, plastic bags, or sizes, shapes or styles of bags, and that many variations of bags or non-tubular items may benefit from the gathering, cinching and/or releasable connection of the material from one point to another without departing from the scope of this invention. Furthermore, the method of delivery of the portion of tape can take many forms including, but not limited to, a roll of several sections of the length of tape, sheets with rows of the length of tape, a box, specialty packaging, or a delivery device to aid in placing the length of tape onto a bag, including, but not limited to hand-held devices or automated devices, and many other dispersal mechanisms meant for assisting the user in the process of adhering the tape to the bag while cinching the gathered portion of bag into the adhesive free zone.

The invention and its advantages and features will be further apparent through the following drawings, descriptions, and claims.

### BRIEF DESCRIPTION OF THE DRAWINGS

FIG. 1 is a top view of the surface of the length of tape that shows the main body of the tape and the location of the perforation/tear line. This is the surface of the body of the invention that would face outwards from the bag to which it is applied.

FIG. 2 is a bottom view of the surface of the length of tape that shows the adhesive and non-adhesive zones of the tape that affect the intended application of the tape to a bag, and shows one possible location of the perforation/tear line.

FIG. 3 is a plan view of the length of tape showing one method of layering the body of tape with an adhesive undercoating on the entire length of tape, and a non-adhesive film over the mid-section of the adhesive surface.

FIG. 4 is a plan view of the length of tape showing a different method of layering the body of tape with adhesive and non-adhesive areas on the underside. Adhesive is only applied to the surfaces of the outer sections, thereby rendering an adhesive free area in the mid section of the length of tape by virtue of the void of adhesive on that surface area.

FIG. 5 shows a perspective view of the tape once it is torn into two parts along the latitudinal perforation/separation line as intended when releasing the tension the invention creates between the bag and surface of the container to which the bag has been placed, so that the bag can be easily removed from the container at the end of the use cycle.

FIG. 6 shows the top view of one example of how multiple lengths of the tape (the invention) may be packaged in a roll type configuration and dispensed from a cardboard or plastic box.

FIG. 7 shows a perspective view of the same example from FIG. 6 of a continuous roll of multiple lengths of tape (the invention) being dispensed off of a standard inner round core through an opening in the box type outer packaging.

FIG. 8 (A,B,C,D,E) shows five views of a progression of steps the user takes during the life of use of the invention.

FIG. 8A is step one, how the user applies the first adhesive area to the bag.

FIG. 8B is step two, how the user gathers a portion of the bag into the adhesive free zone.

FIG. 8C is step three, how the user finishes the application of the invention to the bag by affixing the second adhesive are to the bag on the opposite side of the gathered area.

FIG. 8D is step four, how the user tears the device along the perforation line.

FIG. 8E is step five, how the tearing of the invention, as intended, releases the tension of the bag on the container.

FIG. 9 shows an exploded view of the method in which the opening of a plastic bag is folded to the outside and the bag is inserted into a container for which the bag is intended to line, leaving the turned out area hanging over the outside of the container, as seen in FIG. 10.

FIG. 10 shows a loose plastic bag inserted into a container, whereby the opening of the bag is turned outward and extends down and over the opening rim of the container and can be seen loose to the exterior surface of the container.

FIG. 11 shows the invention in place for its intended use of gathering a portion of the bag and tightening/cinching the loose bag opening in tension to the exterior surface of the container.

FIG. 12 shows the invention's intended ability to be torn into two parts to release the fitting tension created by the invention on the bag to the container, so that the bag can be easily removed from the container at the end of the use cycle.

### DETAILED DESCRIPTION OF THE INVENTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

Turning now to the figures, FIG. 1 illustrates the top surface 2 of the invention. This surface 2 is non-adhesive, and may be made of a substrate of paper, plastic or other material, but must be made of a material which has the physical properties and allowances for tearing along the perforation line 4 with the intended amount of pulling force employed by the user. The substrate should be strong enough to hold the horizontal tension of the bag against the container, even in the perforated area, yet be easily torn along the perforation when latitudinal pressure is applied, such as the user grabbing the mid section with a finger and pulling upward and outward. The surface 2 can be smooth or textured, or contain ink for logos and lettering for identification of the product. The only area of the surface with a distinctive characteristic is the perforated tear line 4, which penetrates through the entire substrate 2 and depth of the invention.

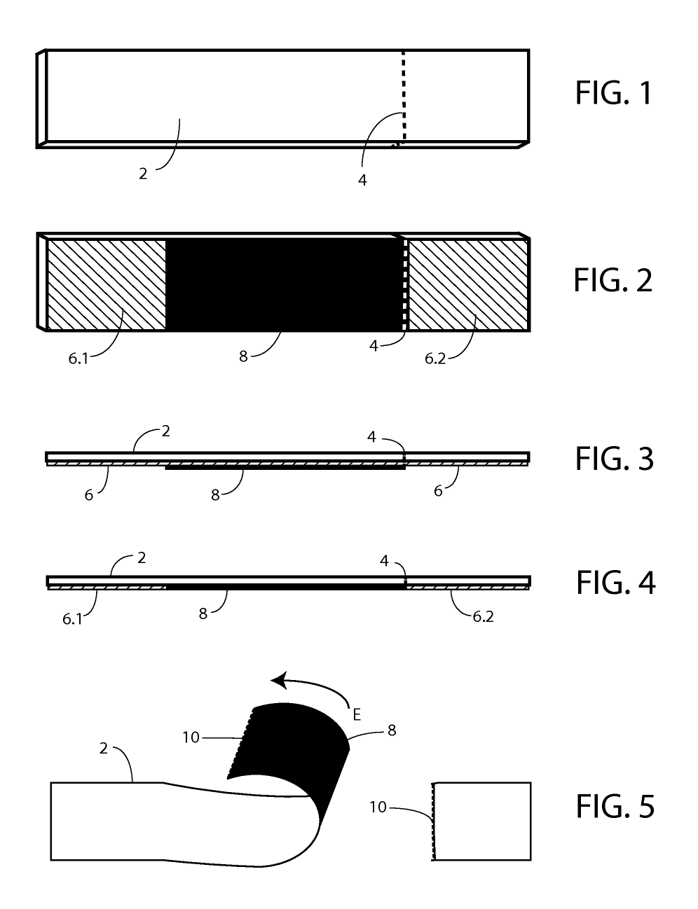

Turning now to FIG. 2, this figure illustrates the opposite side, bottom surface, of the invention shown in FIG. 1. This surface is smooth, and contains three distinctive sections. The two end sections 6.1, 6.2 have been coated with an adhesive. The adhesive should be of the tackiness sufficient to adhere these surfaces 6.1, 6.2 easily to the bag with minimal compressive pressure exerted by the user. It is understood that different bag materials may require different adhesive properties, qualities, and characteristics. The mid section of this surface 8 is a non-adhesive area into which the bag will be gathered upon application of the invention to the bag. The proportions of the adhesive zones to the non-adhesive zone may vary, but should allow enough non-adhesive area to gather the appropriate portion of the intended bag opening to effect a tightening/cinching of the bag around the intended container, and enough adhesive area to ensure a secure connection of the invention to the bag surface in those zones. Again, one can see the perforation/tear line 4 as a feature of the invention that penetrates the entire substrate of the invention.

Looking now at FIG. 3, the figure depicts one of two plan views showing how the invention may be assembled to effect the resulting adhesive layer 6 and non-adhesive area 8 of the bottom surface. In this example, there are three layers. The body of the invention 2, which is the paper, fabric, or plastic substrate, is coated with the adhesive layer 6 over the entire length of the tape body 2. To effect the non-adhesive area in the mid section 8, an addition of a layer of non-stick film or coating is placed over the mid surface area 8. This non stick film may be made of the same material as the substrate 2, or of any other non-adhesive material so long as the thickness and characteristics of the material do not inhibit the application of the adhesive areas 6 of the invention onto the bag, nor the tearing of the substrate as intended along the perforated tear line 4.

FIG. 4 shows the second, and more practical, way of manufacturing the invention, herein this document also referred to as the device. In this example the body of tape 2, is coated only on the end surfaces 6.1, 6.2 with the adhesive. The mid section 8 is left void of adhesive, thereby creating the desired non-adhesive (non-stick) mid section 8 of the invention. The flush finish of the bottom surface will lend to a more effective application of the device, and is the preferred method of manufacture. Once again, in this figure, the tear line 4 is shown at the edge of the non-adhesive area 8, but it is understood that this tear line 4 may be anywhere in, on, or near the non-adhesive area 8 to be effective in ripping the device into two sections.

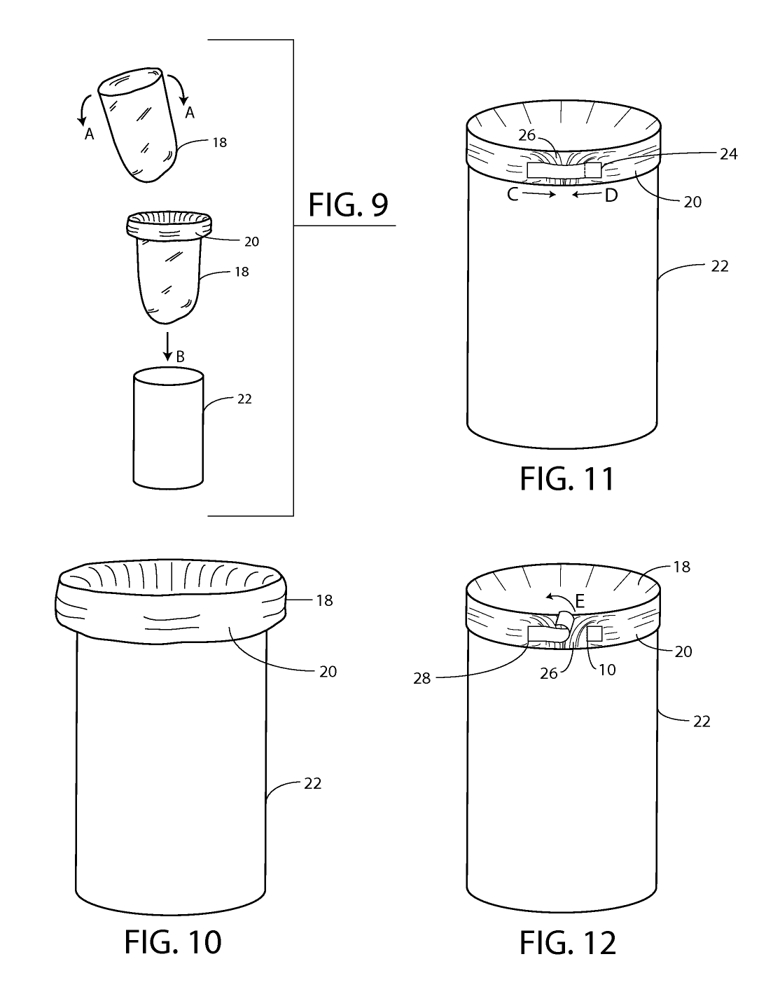

FIG. 5 illustrates the intended tearing of the body of tape 2 into two sections at the end of the use cycle, when the user is ready to remove the bag from its container. When the tape (the invention, device) is in place on the bag, and the bag is tightened as desired around the container for which it lines (see FIG. 9, 10, 11), there is a tension created by the bag around the outer surface of the container. To release this tension, and thereby, allow the user to easily remove the bag from the container, the user may place a finger under the body of tape in the non-adhesive mid section 8 at the gathered area (see FIG. 11) and utilize an upward (or downward) and outward motion E to cause the tape to tear into two sections. The latitudinal perforation line 10 that runs the width of the tape in or next to this non-adhesive section 8 allows the tearing to occur easily and in an intended location to acquire the desired end result of allowing the gathered area of the bag to expand, loosening the tension of the bag in a sufficient manner for easy removal of the bag from the container. The tape remains adhered to the bag at the end surfaces, and the now torn tape is discarded, intentionally, with the bag and its waste.

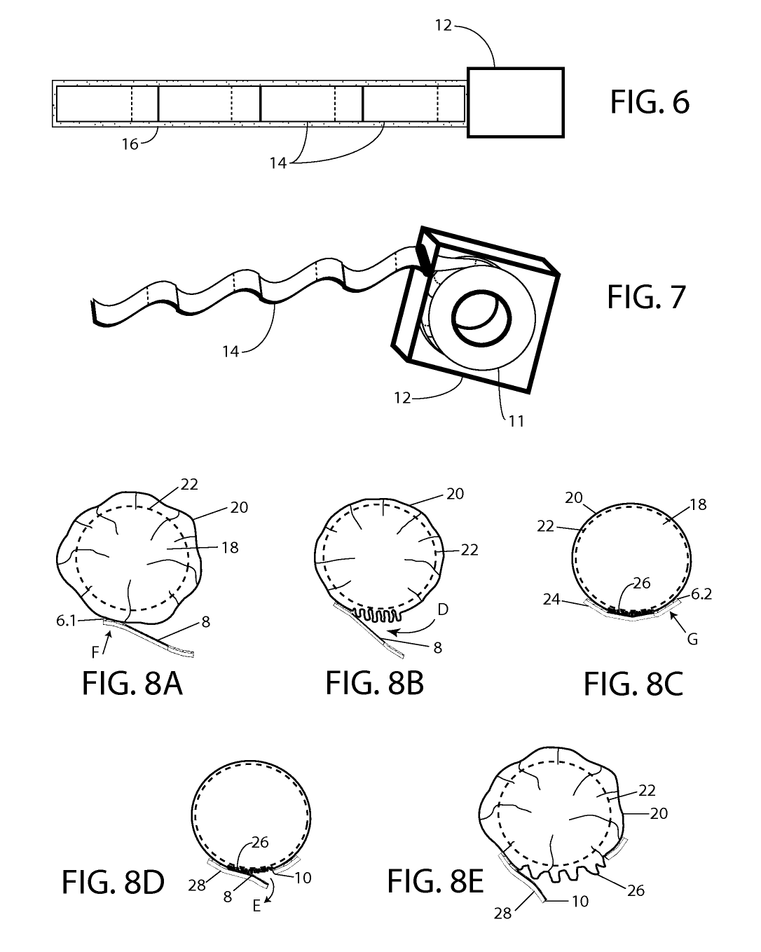

FIGS. 6&7 show two views of one example of how multiple lengths of tape, the invention/device, may be packaged.

FIG. 6 shows a top view of repeating, continuous lengths 14 of the invention placed onto a removable backing 16, which is dispensed from a box type package 12.

FIG. 7 is a perspective view of the same box type packaging, shown with clear side surfaces and opaque end surfaces. The continuous lengths 14 of the invention are rolled onto a core 11, which is placed into a box 12, which has a small slit on one side allowing the tape to be dispensed one at a time from the box. It is comprehensible to envision the manufacturing of the invention to be sheets of an appropriate substrate, such as paper, plastic, or woven fabric, which are coated with an adhesive in only the zones widths needed 6, and then the sheets are die cut and perforated to effect the desired shape and size of the individual pieces of tape, the invention. From the sheets, the pieces of tape will run one after the other, and sheets may be cut into individual rows of pieces of tape (the invention), which may be rolled onto a standard core, for packaging as rolls of pre-cut tape lengths. The packaging and dispensing of the invention may take many forms, and FIGS. 6 & 7 are only two views of one such example of packaging.

Turning now to FIGS. 8A through 8E, the figures are a progression of five steps the user takes during the life cycle of the invention to affect the intended use of the invention.

FIG. 8A is the first step, whereby the user must first adhere one adhesive end 6.1 of the device to the bag 18 that is hanging with its opening 20 loose and unkempt around the container 22 to which it lines. The user applies pressure on the device in the area of the first adhesive end 6.1 in a direction F toward the container, having the bag opening 20 between the device and the container, thereby causing the device to adhere to the bag opening at that location.

FIG. 8B is the second step, in which the user gathers a portion of the bag opening 20 in the direction D of and into the non-adhesive section 8 of the device in a tightening and cinching fashion around the outer surface of the container 22 to effect a smooth, flat, and secure fit of the remainder of the circumference of the bag opening that is in contact with the container.

FIG. 8C continues with step three of the application process affected by the user of the device. The figure shows the final position of the device 24 on the bag 18, and the resulting tightened fit of the bag opening 20 to the container 22. Once the user has gathered a sufficient portion of the bag opening into the non-adhesive section, as described in FIG. 8B, the user then applies pressure to the second adhesive area 6.2 in the direction G toward the container surface 22. This affects the intended holding in place of the gathered portion 26 of the bag by the device 24. After this step, the device is permanently adhered to the surface of the bag on both sides of the gathered portion of bag opening.

FIG. 8D is step four in the use cycle of the device. The figure shows the intentional tearing of the device 28 into two sections along the perforated tear line 10. The user places a finger behind the non-adhesive mid section 8 of the device and in front of the gathered section 26 of the bag opening, and then applies a pulling motion in an upward (or downward) and outward direction E to affect the intended tearing.

FIG. 8E shows the fifth, and last, step in the use cycle of the invention. This figure shows how the tearing of the device 28 into two pieces along the tear line 10 allows the gathered section of bag opening 26 to expand and, thereby, release the tension the bag opening 20 once had on the container 22. At this point the user may easily remove the bag and its contents from the container. The invention remains adhered to the bag, and is at the end of its use cycle after the completion of this step.

Turning now to FIG. 9, the figure is an exploded view illustrating how the open end 20 of the bag 18 to which the invention will be applied is first turned in an outward direction A. Then the bag is inserted into the container 22 in a downward motion B, while the open end 20 hangs over the lip and to the outside of the container.

FIG. 10 shows the bag 18 inserted into the container 22 with the bag opening 20 loose around the lip of the container.

FIG. 11 encompasses the desired result and application of the invention. The figure shows the invention 24 in the proper position on the bag opening 20. The figure further shows the gathering 26 of the bag opening into the non-adhesive mid section. This gathering is what effects the ability of the user to tighten and cinch the bag around the container 22 surface. The user starts by placing one of the adhesive ends onto the bag opening surface, then pulls and gathers a portion of the bag opening into the non-adhesive area in a sideways direction D, and secures the gathered area in place by sticking the 2^{nd} adhesive end to the opposite side of the gathered area with a reverse sideways motion C.

Turning now to FIG. 12, the figure illustrates what occurs at the end of use cycle of the invention. Once the container is full, and the user wishes to disengage the bag from the container, the user must release the tension the bag opening 20 has around the container 22 due to the employment of the invention. This is accomplished by the user placing a finger under the invention in the area of the gathered portion of the bag 26 and pulling in an upward (or downward) and outward motion E from the container. This event will cause the invention 28 to rip into two sections along the intended perforated tear line 10, allowing the gathered area of bag 26 to expand, thereby releasing the tension around the container 22. The user may now remove the bag 18 from the container and discard the bag and contents as desired. The invention is intended to be permanently adhered to the bag once installed, and therefore is disposable with the bag to which it is attached.

What is claimed is:

1. A length of adhesive tape adapted for the use in tightening and/or cinching the opening of a bag around the exterior surface of a container, whereby the user gathers a portion of the bag into a non-adhesive mid section of the tape between two adhesive end sections of the tape.

2. An adhesive tape according to claim 1, in which a weakened area, such as a latitudinal perforation line across the width of the tape, is incorporated in or directly next to the non-adhesive mid section of the tape for the purpose of a tear-line to separate the tape into two sections and release the tension of the bag from around the container surface at the end of the use cycle.

3. An adhesive tape according to claim 1, whereby the non-adhesive mid section may be created by the placement of an overlay of non-adhesive material.

4. A tape according to claim 1, whereby the adhesive end regions may be created by the placement of adhesive material onto those surfaces, thereby rendering the mid section of the tape non-adhesive by way of exclusion.

5. A tape according to claim 1, whereby the non-adhesive section may be further employed by the user as a grab area or finger hold section to aid in the intended tearing of the length of tape into two sections for removal of tension on the bag when removing the bag from the container it lines.

6. An adhesive tape according to claim 1, whereby the result of the gathering and cinching of the bag around the exterior surface of a container creates a smooth, aesthetically pleasing, finish to the bag opening and edge.

7. An adhesive tape according to claim 1, whereby the resulting effect of the invention creates the ability to tighten, cinch and hold the bag opening in tension around the exterior surface of a container, which keeps the bag from falling into the container when items are introduced into the portion of the bag lining the interior of the container.

8. An adhesive tape according to claim 1, whereby the result of the tightening of the bag opening around the exterior surface of a container creates a smooth edge relatively flattened to that surface of container allowing for the easy passage of the bag and container into an additional decorative shell container.
